(19) United States
(12) Patent Application Publication
(10) Pub. No.: US 2015/0106837 A1
(43) Pub. Date: Apr. 16, 2015

(54) SYSTEM AND METHOD TO DYNAMICALLY SYNCHRONIZE HIERARCHICAL HYPERMEDIA BASED ON RESOURCE DESCRIPTION FRAMEWORK (RDF)

(71) Applicant: Futurewei Technologies Inc., Plano, TX (US)

(72) Inventors: Li Li, Bridgewater, NJ (US); Wen Chen, Kearny, NJ (US); Zhe Wang, Piscataway, NJ (US); Wu Chou, Basking Ridge, NJ (US)

(21) Appl. No.: 14/514,192

(22) Filed: Oct. 14, 2014

Related U.S. Application Data
(60) Provisional application No. 61/985,245, filed on Apr. 28, 2014.
(60) Provisional application No. 61/890,788, filed on Oct. 14, 2013.

(51) Int. Cl. H04N 21/858; H04N 21/643; H04N 21/239; H04N 21/241; H04N 21/242

(52) U.S. Cl. CPC H04N 21/8586; H04N 21/241; H04N 21/242; H04N 21/2393; H04N 21/64322
USPC 725/30

(57) ABSTRACT

Various disclosed embodiments include methods and apparatus for dynamically synchronizing hypermedia based on Resource Description Framework (RDF). A method for hypermedia synchronization within a session hosted by a server includes establishing a communications link between the server and a first user device during the session, and generating a first identifier associated with a first uniform resource identifier (URI) that identifies first hypermedia. The method includes receiving, at the server, a request from the first user device including a second URI that identifies second hypermedia to be added to the session, and generating synchronization information providing a temporal relationship between the first URI and the second URI, where the synchronization information includes an RDF triple.

### CROSS-REFERENCE TO RELATED APPLICATIONS

The present application claims priority to U.S. provisional Application No. 61/985,245 filed on Apr. 28, 2014 and claims priority to U.S. provisional Application No. 61/890,788 filed on Oct. 14, 2013, both of which are incorporated herein by reference.

### TECHNICAL FIELD

The present disclosure relates generally to hypermedia synchronization, and more particularly, to dynamically synchronizing hierarchical hypermedia based on Resource Description Framework (RDF), and to coordinating distributed hypermedia synchronization trees with Representational State Transfer (REST) Application Programming Interface (API).

### BACKGROUND

WebRTC (Web Real Time Communication) is an open source protocol for establishing media channels between users. Linked hypermedia (graphics, audio, video, plain text and hyperlinks) enrich the content of these channels. Users can accurately cross-link relevant web information, regardless of its location and format, using spatial and temporal descriptions. Examples are: (1) a rectangle area of the real-time video frame is related to a person's home page, (2) a segment of audio conversation is related to a Google map, (3) a segment of the call is related to a Wikipedia page, and (4) a segment of video lecture is related to a part of the YouTube video.

The linked hypermedia creates not only new meaning, but also new communication modalities: users can co-edit a linked Wikipedia page, users can co-browse a linked Google map, and users can co-view a linked YouTube video.

The linked hypermedia can be created by users or computer programs, such as where each user collaboratively contributes his knowledge, a computer program brings in new information according to scheduled topics, or a computer program augments conversation in real-time (e.g., based on automated face recognition and/or automated speech recognition).

Real-time media access and control in web browsers can be accomplished or performed using various interfaces/specifications, including WebRTC application programming interface (API), HTML5 media API, Stream Processing API, Web Audio API, Mozilla Audio Data API, Media Controller API, Media Capture API, and HTML5 Media Capture API.

Multimodal interactions in real and virtual environments may be accomplished or performed in accordance with various specifications, such as World Wide Web (W3C) VXML 3.0, W3C Multimodal Architecture and Interface, W3C Emma, W3C SCXML, W3C InkML, W3C EmotionML, W3C SMIL, and Web Real-Time 3D.

Various problems exist in the current art in this field. Media uniform resource identifiers (URIs) generated by a web browser are local and only resolvable by the browser, and are temporary and will become invalid after the browser exits. In addition, conventional linked media approaches (e.g. Media Frayment and Media Ontology) have limitations for real-time hypermedia. Media URIs are global and resolvable by servers, Media URIs are persistent and transferrable, and relations between media are defined by fixed ontology.

The present disclosure provides various methods, mechanisms, and techniques to dynamically synchronize hierarchical hypermedia based on RDF.

### SUMMARY

According to one embodiment, there is provided a method for real-time hypermedia synchronization within a session hosted by a server. The method includes establishing a communications link between the server and a first user device during the session, generating a first identifier associated with a first uniform resource identifier (URI) that identifies first hypermedia, receiving, at the server, a request from the first user device including a second URI that identifies second hypermedia to be added to the session, generating synchronization information providing a temporal relationship between the first URI and the second URI, wherein the synchronization information includes a resource description framework (RDF) triple having a subject, a <sync> predicate, and an object, and storing the generated synchronization information.

In another embodiment, there is provided an apparatus for real-time hypermedia synchronization within a session. The apparatus includes a processor and memory coupled to the processor. The apparatus is configured to establish a communications link between the apparatus and a first user device during the session, generate a first identifier associated with a first uniform resource identifier (URI) that identifies first hypermedia, and receive a request from the first user device including a second URI that identifies second hypermedia to be added to the session. The apparatus is configured to generate synchronization information providing a temporal relationship between the first URI and the second URI, wherein the synchronization information includes a resource description framework (RDF) triple having a subject, a <sync> predicate, and an object, and store the generated synchronization information.

In yet another embodiment, there is provided a method for transforming a hypermedia synchronization tree to a representational state transfer (REST) resource model, including generating and storing a first hypermedia synchronization tree, the first tree associated with a first user in communication with a server during a session, the first tree defining a relation between a plurality of uniform resource identifiers (URIs) associated with the session, and generating and storing a second hypermedia synchronization tree, the second tree associated with a second user in communication with the server during the session, the second tree defining a relation between the plurality of URIs. The method includes modifying the first tree in response to receiving a request from the first user including a URI that identifies hypermedia to be added to the session, and updating the second tree according to the URI that identifies the hypermedia to be added, the updated second tree configured to enable the second user to access the hypermedia via the URI.

In another embodiment, there is provided a method for real-time hypermedia synchronization during a session between a first user device and a second user device. The method includes generating, at the first user device, a first identifier associated with a first uniform resource identifier (URI) that identifies first hypermedia. The method includes receiving, at the first user device, a request from a user that includes a second URI that identifies second hypermedia to be added to the session by the first user device. The method includes generating synchronization information providing a temporal relationship between the first URI and the second URI, wherein the synchronization information includes a resource description framework (RDF) triple having a subject, a <sync> predicate, and an object. The method includes storing the generated synchronization information at the first user device.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a diagram of an illustrative communication system that can dynamically synchronize hierarchical hypermedia based on RDF according to one embodiment;

FIGS. 2A and 2B illustrate example devices that can implement dynamically synchronized hierarchical hypermedia based on RDF according to one embodiment;

FIG. 3 illustrates a media synchronization tree of a first user in a call to a second user according to one embodiment;

FIG. 4 illustrates a media synchronization tree of the second user in a call to the first user according to one embodiment;

FIG. 5 illustrates a flow diagram for initial tree construction based on a relative delay according to one embodiment;

FIG. 6 illustrates a flow diagram for initial tree construction based on a client time according to one embodiment;

FIG. 7 illustrates a process for playing a <sync> triple according to one embodiment;

FIG. 8 illustrates a process for playing a relative delay according to one embodiment;

FIG. 9 illustrates system architectures that illustrate embodiments of hypermedia synchronization trees with a REST API;

FIG. 10 illustrates a resource model of a hypermedia synchronization tree according to one embodiment;

FIG. 11 illustrates an operation to add a new edge for REST API over HTTP 1.1 according to one embodiment;

FIG. 12 illustrates an operation to retrieve a triple for REST API over HTTP 1.1 according to one embodiment;

FIG. 13 illustrates operations that illustrate embodiments for updating a tree for REST API over HTTP 1.1;

FIG. 14 illustrates an operation to delete an edge for REST API over HTTP 1.1 according to one embodiment;

FIG. 15 illustrates an operation to add a new edge based on JSON for REST API over WebSocket according to one embodiment;

FIG. 16 illustrates an operation to retrieve a triple based on JSON for REST API over WebSocket according to one embodiment;

FIG. 17 illustrates an operation to update a tree based on JSON for REST API over WebSocket according to one embodiment;

FIG. 18 illustrates an operation to delete an edge based on JSON for REST API over WebSocket according to one embodiment;

FIG. 19 illustrates a flow diagram illustrating a method of constructing a hypermedia synchronization tree according to one embodiment;

FIG. 20 illustrates a flow diagram illustrating a method of transforming a hypermedia synchronization tree to a representational state transfer (REST) resource model;

FIG. 21 illustrates a flow diagram illustrating a method 2100 for real-time hypermedia synchronization within a session hosted by a server;

FIG. 22 illustrates a flow diagram illustrating a method 2200 for transforming a hypermedia synchronization tree to a representational state transfer (REST) resource model; and

FIG. 23 illustrates a flow diagram illustrating a method 2300 for real-time hypermedia synchronization during a session between a first user device and a second user device.

### DETAILED DESCRIPTION

One solution is to define hypermedia synchronization as the lowest common denominator to provide openness and interoperability. Conventional media synchronization standard SMIL is not applicable to real-time hypermedia. SMIL was designed for single-user presentations, and an SMIL document is static and cannot be changed once it is playing. In addition, it is difficult for SMIL to define hierarchical and multi-point hypermedia synchronizations.

A challenge with real-time hypermedia synchronization is that it needs to support multi-user interactions. In addition, any hypermedia can be dynamically added, changed and removed while the hypermedia is playing. Hierarchical and multi-point hypermedia synchronization is essential to define accurate relations between hypermedia.

One solution to the above-mentioned real-time hypermedia synchronization challenge is to use a dynamic hypermedia synchronization engine like Mozilla Popcorn Maker. Although Mozilla Popcorn Maker provides dynamic hypermedia synchronization, it is designed for single-user presentation and has limitations like SMIL. Furthermore, it uses proprietary JavaScript representations which have no interoperability with relevant Web standards. For example, users are locked in to a particular web application while WebRTC allows different web applications to communicate. As another example, user interfaces (presentation) are not separated from data models, such that it prevents users from (1) viewing the same data model in different ways based on application design, user preferences, and device capabilities; and (2) recording the data model for future playback, search, analysis, reuse and reasoning.

The present disclosure proposes a real-time collaboration system using web technologies that allows multiple users to construct, manipulate, and exchange a type of link related to multimedia, where there is a temporal relation between different multimedia. The temporal relation can be represented in the form of a data tree structure, referred to herein as a hypermedia synchronization tree. Within the tree, there are nodes and edges connecting the nodes. In an exemplary embodiment, the nodes are a particular form of URI referred to as “media fragment” URIs. The media fragment URIs are configured to pinpoint an interval or a region within a multimedia stream.

The present disclosure proposes using a resource description framework (RDF) <sync> predicate that can link two media fragment URIs. The RDF <sync> predicate defines the edges between the nodes where the nodes define the intervals of the multimedia. The present disclosure proposes combining RDF and media fragment to model the hypermedia synchronization tree, which can be used for both presentation and multi-user conferences.

In a particular embodiment, the hypermedia synchronization tree comprises nodes, the nodes comprising URIs that identify hypermedia, including session, real-time video, real-time audio, image, html, text, map, etc. using media fragment syntax with a relative delay extension. The hypermedia synchronization tree further includes edges that represent temporal synchronization between nodes using the RDF <sync> predicate. Additional information about the hypermedia may be described using auxiliary predicates such as <constrain> and <type>.

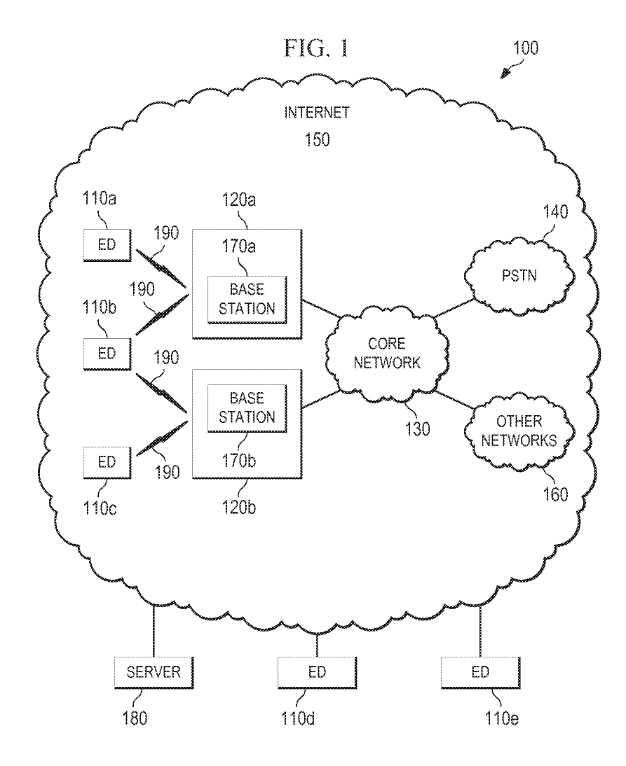

FIG. 1 illustrates an example communication system 100 that can dynamically synchronize hierarchical hypermedia based on RDF. In general, the system 100 enables multiple wireless or wired users to transmit and receive data and other content. The system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA).

In this example, the communication system 100 includes electronic devices (ED) 110a-110e, radio access networks (RANs) 120a-120b, a core network 130, a public switched telephone network (PSTN) 140, the Internet 150, and other networks 160, and one or more servers 180. While certain numbers of these components or elements are shown in FIG. 1, any number of these components or elements may be included in the system 100.

The EDs 110a-110e are configured to operate and/or communicate in the system 100. For example, the EDs 110a-110e are configured to transmit and/or receive via wireless or wired communication channels. Each ED 110a-110e represents any suitable end user device and may include such devices (or may be referred to) as a user equipment/device (UE), wireless transmit/receive unit (WTRU), mobile station, fixed or mobile subscriber unit, cellular telephone, personal digital assistant (PDA), smartphone, laptop, computer, touchpad, wireless sensor, or consumer electronics device, all which include and incorporate a browser application.

The RANs 120a-120b here include base stations 170a-170b, respectively. Each base station 170a-170b is configured to wirelessly interface with one or more of the EDs 110a-110c to enable access to the core network 130, the PSTN 140, the Internet 150, and/or the other networks 160. For example, the base stations 170a-170b may include (or be) one or more of several well-known devices, such as a base transceiver station (BTS), a Node-B (NodeB), an evolved NodeB (eNodeB), a Home NodeB, a Home eNodeB, a site controller, an access point (AP), or a wireless router. EDs 110d-110e are configured to interface and communicate with the Internet 150 and may access the core network 130, the PSTN 140, and/or the other networks 160, which may include communicating with the server 180.

In the embodiment shown in FIG. 1, the base station 170a forms part of the RAN 120a, which may include other base stations, elements, and/or devices. Also, the base station 170b forms part of the RAN 120b, which may include other base stations, elements, and/or devices. Each base station 170a-170b operates to transmit and/or receive wireless signals within a particular geographic region or area, sometimes referred to as a “cell.” In some embodiments, multiple-input multiple-output (MIMO) technology may be employed having multiple transceivers for each, cell.

The base stations 170a-170b communicate with one or more of the EDs 110a-110c over one or more air interfaces 190 using wireless communication links. The air interfaces 190 may utilize any suitable radio access technology.

It is contemplated that the system 100 may use multiple channel access functionality, including such schemes as described above. In particular embodiments, the base stations and EDs implement LTE, LTE-A, and/or LTE-B. Of course, other multiple access schemes and wireless protocols may be utilized.

The RANs 120a-120b are in communication with the core network 130 to provide the EDs 110a-110c with voice, data, application, Voice over Internet Protocol (VoIP), or other services. Understandably, the RANs 120a-120b and/or the core network 130 may be in direct or indirect communication with one or more other RANs (not shown). The core network 130 may also serve as a gateway access for other networks (such as PSTN 140, Internet 150, and other networks 160). In addition, some or all of the EDs 110a-110c may include functionality for communicating with different wireless networks over different wireless links using different wireless technologies and/or protocols. Instead of wireless communication (or in addition thereto), the EDs may communicate via wired communication channels to a service provider or switch (not shown), and to the internet 150.

Although FIG. 1 illustrates one example of a communication system, various changes may be made to FIG. 1. For example, the communication system 100 could include any number of EDs, base stations, networks, or other components in any suitable configuration.

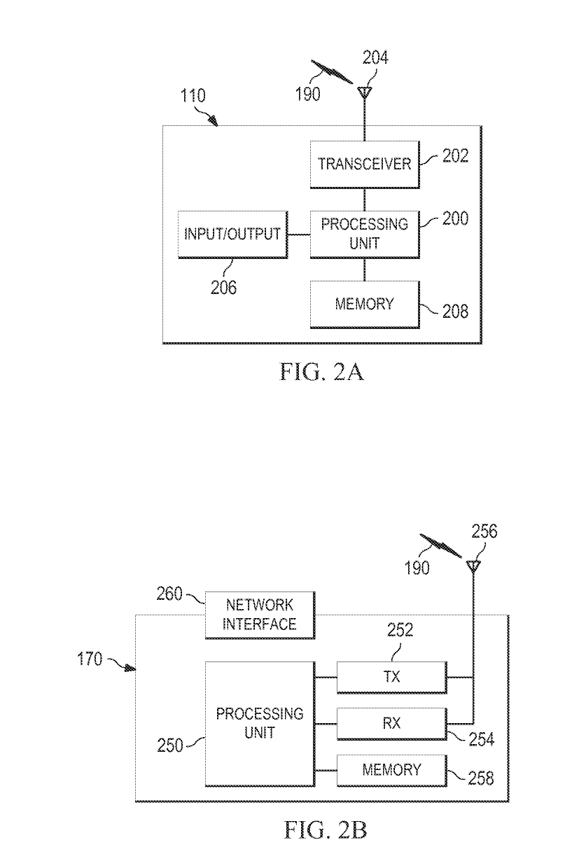

FIGS. 2A and 2B illustrate example devices that may implement the methods and teachings according to this disclosure. In particular, FIG. 2A illustrates an example ED 110, and FIG. 2B illustrates an example server 190. These components could be used in the system 100 or in any other suitable system.

As shown in FIG. 2A, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the system 100. The processing unit 200 also supports the methods and teachings described in more detail above. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna or NIC (Network Interface Controller) 204. The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110, and one or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150). The input/output devices 206 facilitate interaction with a user or other devices (network communications) in the network. Each input/output device 206 includes any suitable structure for providing information to or receiving/providing information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software or firmware instructions executed by the processing unit(s) 200 and data used to reduce or eliminate interference in incoming signals. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 2B, the server 180 includes at least one processing unit 250, at least one transmitter 252, at least one receiver 254, one or more antennas 256, one or more wired network interfaces 260, and at least one memory 258. The processing unit 250 implements various processing operations of the server 180, such as signal coding, data processing, power control, input/output processing, or any other functionality. The processing unit 250 can also support the methods and teachings described in more detail above. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. While a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s).

Additional details regarding EDs 110 and server 180 are known to those of skill in the art. As such, these details are omitted here for clarity.

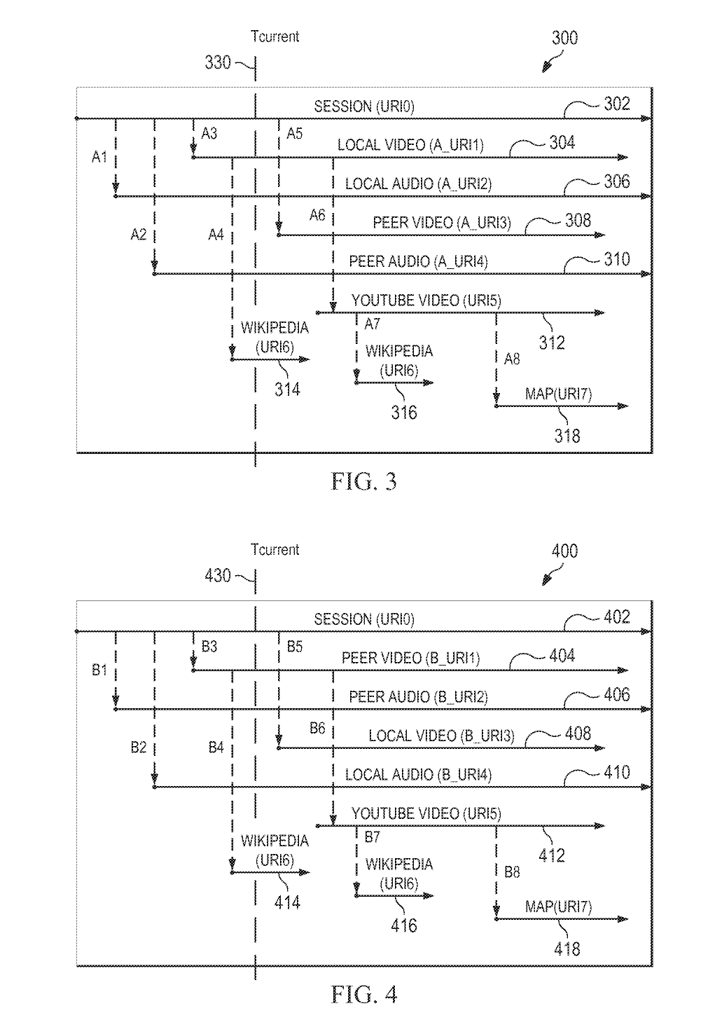

Turning to FIG. 3, a media synchronization tree 300 of a first user (e.g., User A) in a call to a second user (e.g., User B) is illustrated. As will be appreciated, the first and second users are user devices, and may be two of the EDs 110 shown in FIGS. 1 and 2A, each operating or executing a browser application.

The media synchronization tree 300 includes a session 302 identified by (URI0) which is the root of the media synchronization tree 300. Each of the “horizontal arrows” 304-318 represents a node (e.g., media fragment URI) that identifies hypermedia, where a length of the arrow represents time duration of the corresponding media. Each of the “vertical lines” A1-A8 represents an edge. Each edge represents either (1) a temporal synchronization between nodes and a starting position, or (2) a time within the session at which the corresponding media starts. A current session time 330 is represented by T_{current}.

For example, as illustrated in FIG. 3, at A1, browser A receives local audio 306 identified by (A_URI2) from a microphone. At A2, browser A receives peer audio 310 identified by (A_URI4) from browser B. At A3, browser A receives local video 304 as identified by (A_URI1) from a camera. At A4, User A links a Wikipedia page 314 as identified by (URI6) to the local video 304 for a time interval. At A5, browser A receives peer video 308 as identified by (A_URI3) from browser B. Referring to A6, User A links a segment of YouTube video 312 as identified by (URI5) to the local video 304. At A7, User A links another Wikipedia page 316 as identified by (URI6) to a segment of the YouTube video 312. As illustrated at A8, User A links a map 318 as identified by (URI7) to a segment of the YouTube video 312. The YouTube video 312 and the Wikipedia pages 314, 316 are referred to herein as added media that is added by the User A to the session 302 during the call. It will be appreciated that the system may automatically generate the local video 304, the local audio 306, the peer video 308, and the peer audio 310. For example, during the session 302 (e.g., at A1), the User A may activate a microphone on the electronic device and the local audio 306 may be automatically generated. At a later time during the session 302 (e.g., A3) the User A may activate her camera on the electronic device and the local video 304 may be automatically generated.

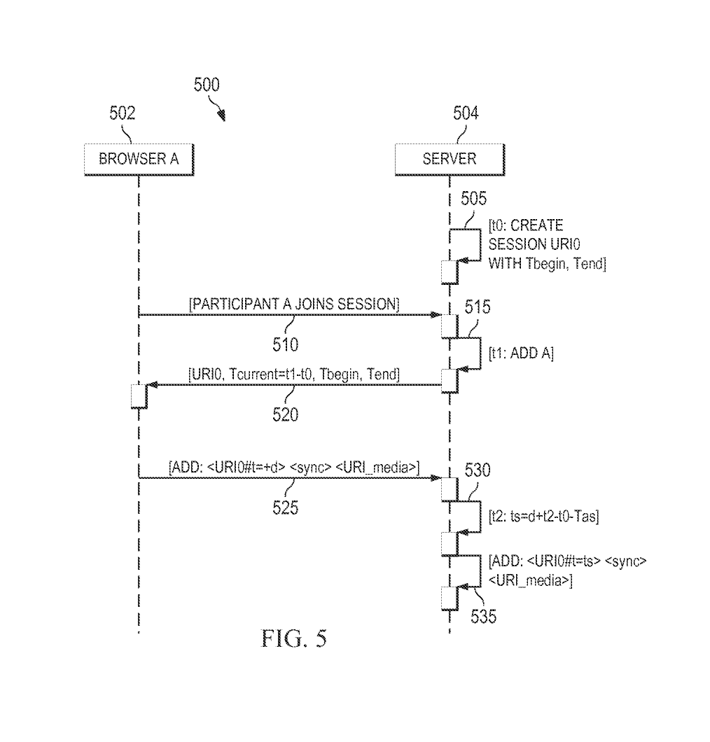

Turning to FIG. 4, a media synchronization tree 400 of User B in a call with User A is illustrated. The media synchronization tree 400 includes a session 402 identified by (URI0) which is the root of the media synchronization tree 400. Each of the horizontal arrows 404-418 represents a node or URI that identifies hypermedia, where a length of the arrow represents time duration of the corresponding media. Each of the vertical lines B1-B8 represents an edge. Each edge represents a temporal synchronization between nodes and a starting position, or a time within the session at which the corresponding media starts. A current session time 430 is represented by T_{current}.

For example, as illustrated in FIG. 4, at B1, browser B receives peer audio 406 identified by (B_URI2) from browser A. At B2, browser B receives local audio 410 identified by (B_URI4) from a microphone. At B3, browser B receives peer video 404 as identified by (B_URI1) from browser A, and browser B generates B4 (e.g., the Wikipedia page 414 as identified by (URI6) linked to the peer video 404) from A4. At B5, browser B receives local video 408 as identified by (B_URI3) from a camera, and browser B generates B6 (e.g., a segment of YouTube video 412 as identified by (URI5) to the peer video 404) from A6. Browser B generates B7 (e.g., another Wikipedia page 416 as identified by (URI6) linked to a segment of the YouTube video 412) from A7, and browser B generates B8 (e.g., links a map 418 as identified by (URI7) to a segment of the YouTube video 412) from A8.

Turning to Table 1 (see below), an illustration of a media synchronization tree represented as <sync> triples is shown. As illustrated, Table 1 includes a first column referred to as a “Relation” column, a second column referred to as an “RDF” column, and a third column referred to as a “Comment” column. Table 1 also includes eight rows A1-A8 that correspond to the nodes A1-A8 of FIG. 3. For example, row A1 includes an RDF triple <URI0#t=10> <sync> <A_URI2>, where <URI0#t=10> represents the subject, <sync> represents the predicate, and <A_URI2> represents the object of the RDF triple. A syntax of the RDF triple is defined by the media fragment URI, where the nomenclature of the subject <URI0#t=10> indicates that the browser is pointing to the tenth second (e.g., #t=10) of the media identified by URI0. The nomenclature of the object <A_URI2> indicates that the object URI is a “regular” URI.

Putting the subject <URI0#t=10> and the object <A_URI2> together with the <sync> predicate acts like an instruction to the machine to synchronize the object URI (e.g., A_URI2) when the first resource (e.g., URI0) reaches the tenth second (e.g., #t=10). In other words, the media synchronization tree is attempting to synchronize the intervals of two different media streams.

Referring to the comment column of row A1, the nomenclature sync A_URI2 [s,e) with URI0 [10,e) indicates synchronization of a portion of the media stream identified by A_URI2 with a portion of the media stream identified by URI0. To illustrate, the nomenclature sync A_URI2 [s,e) indicates a start time (e.g., [“s”—start at the beginning of the media stream identified by A_URI2) and an end time (e.g., “e”—open ended or until the end of the media stream identified by A_URI2), thereby defining an interval of the media stream identified by A_URI2. Similarly, the nomenclature URI0 [10,e) indicates a start time (e.g., “10”—start when the media stream identified by URI0 reaches the tenth second) and an end time (e.g., “e”—open ended or until the end of the media stream identified by URI0) of the media stream identified by URI0.

Turning to Table 2 (see below), an illustration of auxiliary predicates <constraint> and <type> is shown. The auxiliary predicates are configured so as to allow reconstruction of the media at a later time. For example, assume that User A and User B have a conversation or conference and that media streams were involved, and that the system saves the conference. A month later someone may wish to look at the conference again, such that the system must reconstruct the conference. The auxiliary predicates provide additional information so that the system can reconstruct the session at a later time. For example, the <constraint> predicate records the constraints used to create the media on a browser so the media can be recreated on a different browser at a different time if the media is not recorded. To illustrate, the <constraint> predicate may relate local video to the WebRTC constraint so if a user wishes to reconstruct the media stream, the user can send the <constraint> predicate to the WebRTC API so that the WebRTC API can reconstruct media that is very close to what the conference initially was one month ago. The <type> predicate defines the Internet media type of the media stream, which is beneficial for obtaining the correct codec so that the media can be rendered correctly in any web browser.

TABLE 1
Media Synchronization Tree represented as
<sync> Triples

| Relation | RDF | comment |
|---|---|---|
| A1 | <URI0#t=10> <sync> | sync A_URI2 [s,e) with |
| | <A_URI2> | URI0 [10,e); |
| A2 | <URI0#t=20> <sync> | sync A_URI4 [s,e) with |
| | <A_URI4> | URI0 [20,e); |
| A3 | <URI0#t=30> <sync> | sync A_URI1 [s,e) with |
| | <A_URI1> | URI0 [30,e); |
| A4 | <A_URI1#t=10> <sync> | sync URI6 [s,10) with |
| | <URI6#t=,10> | A_URI1 [10,e) |
| A5 | <URI0#t=70> <sync> | sync A_URI3 [0,e) with |
| | <A_URI3> | URI0 [70,e) |
| A6 | <A_URI1#t=50> <sync> | sync URI5 [30, 120) with |
| | <URI5#t=30,120> | A_URI1 [50,e) |
| A7 | <URI5#t=20> <sync> | sync URI6 [0,5) with |
| | <URI6#t=,5> | URI5 [20,e) |
| A8 | <URI5#t=60> <sync> | sync URI7 [0,10) with |
| | <URI6#t=,10> | URI5 [60,e) |

TABLE 2
<Constraint> and <Type> Triples

| Relation | RDF | comment |
|---|---|---|
| | <A_URI2> <constraint> | {Constraint} from |
| | “{Constraint}” | getUserMedia( ) to restore |
| | | the media |
| | <A_URI2> <type> | Specify the media type of |
| | “audio/opus” | the resource |
| | <A_URI1> <constraint> | {Constraint} from |
| | “{Constraint}” | getUserMedia( ) to restore |
| | | the media |
| | <A_URI1> <type> | Specify the media type of |
| | “video/vp8” | the resource |
| | <URI5> <type> | specify the media type of |
| | “video/mpeg” | the resource |
| | <URI7> <type> | Specify the media type of |
| | “text/html” | the resource |

Once a user expresses an intention to construct a media synchronization tree, the system responds to the user's action by constructing the tree by adding an edge to the tree, where the edge is defined by the RDF <sync> predicate. To illustrate, a tree may be constructed dynamically by the operations: Add(edge, tree): add an edge (<parent> <sync> <child>) to the tree without scheduling the nodes. For example, edges A1, A2, A3 and A5 for User A in FIG. 3 are constructed in this manner. Similarly, edges B1, B2, B3 and B5 in FIG. 3 are constructed in this manner. The edges can also be played. To illustrate, an edge may be played by the operations: Play(edge, tree): schedule a task to synchronize the nodes in the edge. For example, edges A4, A6, A7 and A8 for User A in FIG. 3 are played in this manner. Similarly, edges B4, B6, B7 and B8 in FIG. 3 are played in this manner.

Turning to FIG. 5, there is illustrated a flow diagram 500 for initial tree construction based on a relative delay in accordance with one embodiment of the present disclosure, where a server calculates time intervals. The flow diagram 500 includes a browser 502 (e.g., Browser A) and a server 504 (e.g., Server). The server 504 may include an operating system that provides executable program instructions for the general administration and operation of that server, and typically will include a computer-readable medium storing instructions that, when executed by a processor of the server 504, allow the server 504 to perform its intended functions. Suitable implementations for the operating system and general functionality of the servers are known or commercially available, and are readily implemented by persons having ordinary skill in the art. As will be appreciated, the server 504 may be the server 190 as described in FIGS. 1 and 2B, while the browser may be implemented or executing in a user device, such as one of the EDs 110 as described in FIGS. 1 and 2A.

The server 504 creates a session URI0 (step 505). When creating the session, the server 504 remembers the beginning time (e.g., Tbegin) and the end time (e.g., Tend) of the session, as well as when the session was created (e.g., t0). At some point in time after the session begins, the browser 502 joins the session (step 510), and the server 504 remembers when the browser 502 joins the session (e.g., t1) (step 515). The server 504 responds by sending a message to the browser 502 that includes the session URI0 (e.g., telling the browser 502 that the session that you just joined is URI0), the current time (e.g., Tcurrent=t1−t0), the beginning time (e.g., Tbegin), and the end time (e.g., Tend) of the session.

When the browser 502 wants to add URI media to the session at a time t2, it sends a triple [add: <URI#t=+d> <sync> <URI_media> ] to the server 504 (step 525). The syntax “#t=+d” contained in the triple's subject (e.g., <URI#t=+d>) tells the server to add the triple to the tree with delay “d”. After the server 504 receives the triple, the server 504 determines a relative delay by extracting the delay “d” and calculating the session time ts (step 530). The session time ts is calculated from “d” and the offset between t2, t0, and Tas, where Tas is an estimated network delay from the browser 502 to the server 504 (e.g., [t2: ts=d+t2−t0−Tas]. The relative delay is converted to an absolute delay and added to the triple (step 535) (e.g., [add: <URI0#t=ts> <sync> <URI_media>). It will be appreciated that the above flow can be repeated for all local media.

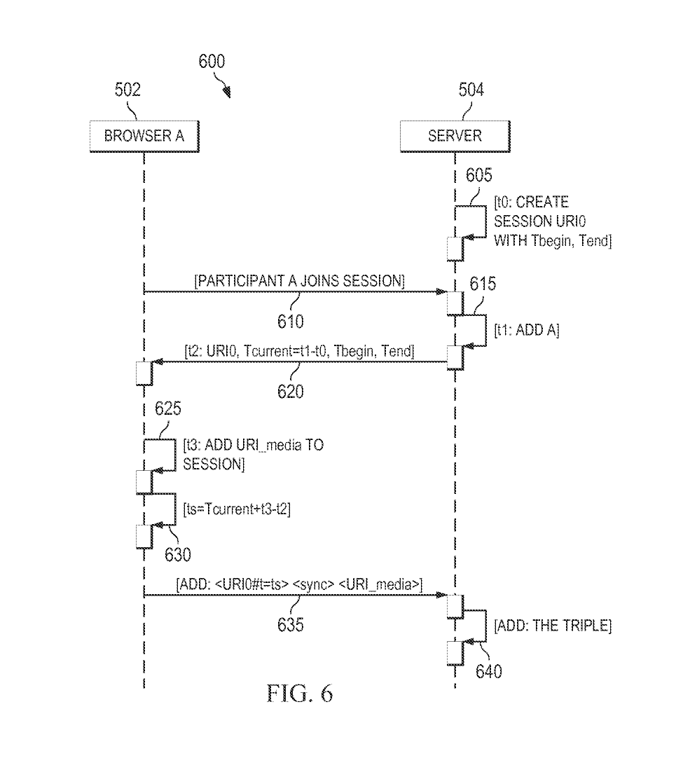

Turning to FIG. 6, there is illustrated a flow diagram 600 for initial tree construction based on a client time in accordance with one embodiment of the present disclosure, where a client calculates time intervals. The flow diagram 600 includes the browser 502 (e.g., Browser A) and the server 504 (e.g., Server).

As shown, the server 504 creates a session URI0 (step 605). When creating the session, the server 504 remembers the beginning time (e.g., Tbegin) and the end time (e.g., Tend) of the session, as well as when the session was created (e.g., t0). At some time after the session begins, the browser 502 joins the session (step 610), and the server 504 remembers when the browser 502 joins the session (e.g., t1) (step 615). The server 504 responds at time t2 by sending a message to the browser 502 that includes the session URI0 (e.g., telling the browser 502 that the session that you just joined is URI0), the current time (e.g., Tcurrent=t1−t0), the beginning time (e.g., Tbegin), and the end time (e.g., Tend) of the session.

When the browser 502 wants to add URI media to the session at time t3 (step 625), the browser 502 estimates the current session time ts (step 630) by using its own clock. The current session time ts is estimated by adding Tcurrent and t3, and subtracting t2 (e.g., ts=Tcurrent+t3−t2). The estimated ts is converted to an absolute ts (step 635) (e.g., [add: <URI0#t=ts> <sync> <URI_media>) and added to the triple (step 640). It will be appreciated that the above flow can be repeated for all local media.

Turning to FIG. 7, there is illustrated a process 700 for playing a <sync> triple. The process 700 includes a representation of an “X” media 702 or subject resource that has been playing (e.g., a movie clip; a YouTube resource; etc.) and a representation of a “Y” media 704 that is being attached or that is attempted to be attached to the “X” media 702. The interval of the “X” media 702 is defined by a starting point Xₛ 706 of the “X” media and an ending point Xₑ 708 of the “X” media, and the interval of the “Y” media 704 is defined by a starting point Yₛ 716 of the “Y” media and an ending point Yₑ 718 of the “Y” media. A current position of the “X” media 702 is represented by Xₚ 710.

In order to determine how long and whether to play the “Y” media 704 attached to the “X” media 702, consideration is given to the starting point Xₛ 706, the current position Xₚ 710, the ending point Xₑ 708, the starting point Yₛ 716, and the ending point Yₑ 718 such that the determination is based on an intersection of the values of those variables as illustrated at 720. To illustrate, in the example shown in FIG. 7, assume that the starting point Yₛ 716 of the “Y” media 704 is 10 seconds, the ending point Yₑ 718 of the “Y” media 704 is 100 seconds, the starting point Xₛ 706 of the “X” media 702 is 20 seconds, the current position Xₚ 710 of the “X” media 702 is 40 seconds, and the ending point Xₑ 708 of the “X” media is 70 seconds.

As illustrated, the starting point Yₛ 716 and the ending point Yₑ 718 intersect with the starting point Xₛ 706, the current position Xₚ 710, and the ending point Xₑ 708. Accordingly, the time allocated to play the “Y” media 704 is a time between Xₚ 710 and Xₑ 708. Therefore, in the illustrated example, even though the interval of the “Y” media is 90 seconds (e.g., Yₑ 718 (e.g., 100 seconds)−Yₛ 716 (e.g., 10 seconds)=90 seconds), only the portion of the “Y” media 704 corresponding to the time between Xₚ 710 (e.g., 40 seconds) and Xₑ 708 (e.g., 70 seconds) will play.

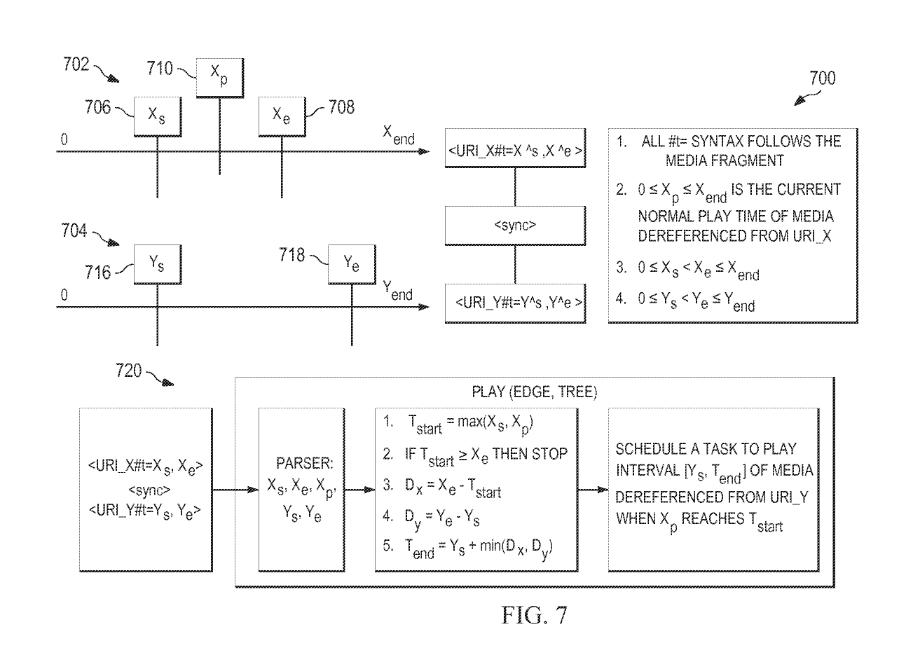

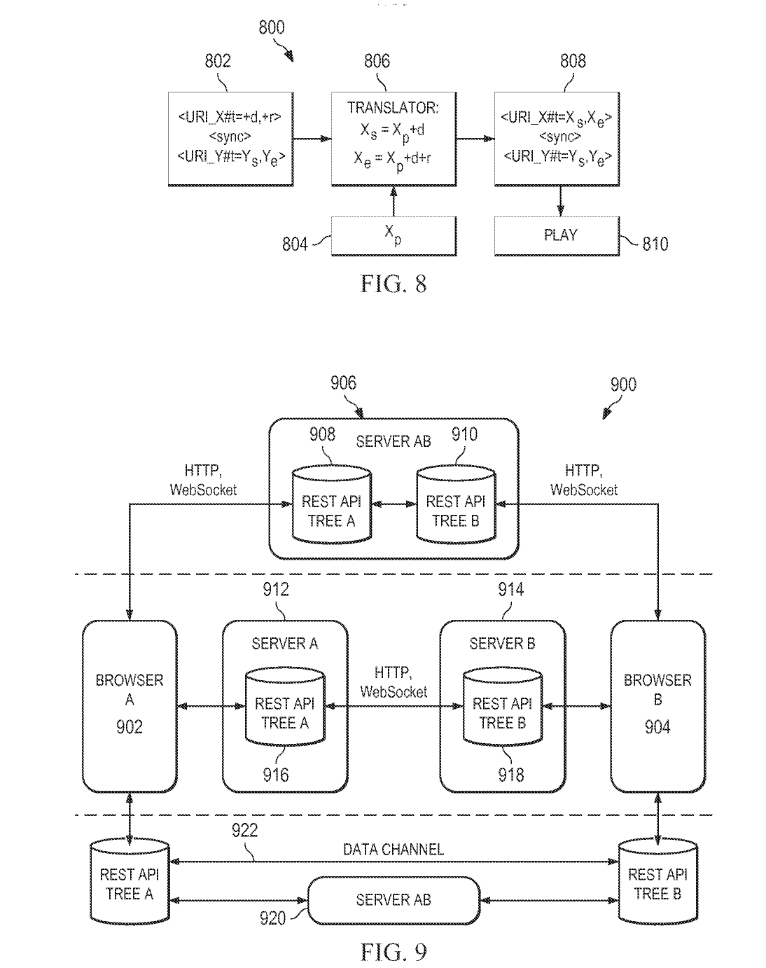

Turning to FIG. 8, there is illustrated a process 800 for playing a relative delay, where the <sync> predicate reinterprets the interval semantics of the W3C Media Fragment. Instead of clipping the parent media, URI_X intervals serve as synchronization points between parent and child media. The process includes a first triple 802 comprising a URI having a relative delay +d instead of an absolute play time, a current position Xₚ 804 of the “X” media, a translator 806 configured to translate the relative delay into an absolute play time, and a second triple 808. The second triple 808 includes a URI having the absolute play times translated by the translator 806 without any relative delays. The second triple 808 is played 810 according to the process described above with respect to FIG. 7.

One of the benefits of the embodiments described above includes having one language for both presentation and communication. Another benefit is that synchronization relations can be added recursively and changed dynamically. Another benefit is that RDF representations allow connection to large linked media and linked data stores for further analysis and reasoning.

Additional embodiments of the present disclosure include systems and methods to coordinate distributed hypermedia synchronization trees with REST API. The hypermedia synchronization tree can be used to support selective context sharing in a multi-user conference. In a collaboration system such as a multi-user conference, each user has its own tree. Changes or updates made to the nodes and edges of a user's tree should be coordinated with the trees of other users such that all the users maintain a consistent view of the conference. For this purpose, an efficient, fine-grained and flexible update protocol for distributed trees is desirable, which can be located on web servers or web browsers.

However, current RDF update protocols, e.g., SPARQL Update and Sesame REST API, are optimized to update sets of triples where the repository of the triples is relatively stable, not on an individual RDF statement and its components (e.g. subject and object). In addition, some current RDF synchronization mechanisms, such as RDF Delta, require both source and target information in order to update, which does not work well in concurrent updates with race conditions. Another problem is that the <sync> triples may appear to be disconnected.

It is desirable to update individual <sync> triples because the user may frequently change or adjust during the time interval of each triple. The present disclosure proposes a mechanism to navigate between triples as a user navigates between web pages using a REST resource model that treats each triple as a resource so that each triple can be connected for navigation.

The present disclosure proposes two REST protocols: one based on HTTP 1.1 and the other based on JSON to actually carry out the basic operations (e.g., to create an edge; to retrieve an edge; to delete an edge; and to update a tree.) In one embodiment, a method to transform a hypermedia synchronization tree to a connected resource model is described, where each edge (e.g., a <sync> RDF triple) of the tree is modeled as a resource to allow fine-grained and efficient updates on the edges and nodes. Super nodes are used to link related edge resources for partial retrieval and tree navigation.

In another embodiment, a method to derive a REST API over HTTP 1.1 and JSON protocols based on the resource model is described, where incoming and outgoing representations for an edge creation operation are defined, incoming and outgoing representations for an edge retrieval operation are defined, incoming and outgoing representations for a tree update operation are defined, and incoming and outgoing representations for an edge deletion operation are defined.

Turning to FIG. 9, three different high level system architectures 900 (shown partially delineated by dotted lines) are shown that illustrate embodiments of hypermedia synchronization trees with REST API. According to one embodiment (upper architecture), a first browser 902 (e.g., Browser A) and a second browser 904 (e.g., Browser B) are engaged in a communication session through a server 906 (e.g., Server AB) that is shared between Browser A 902 and Browser B 904. A first tree (e.g., Tree A) associated with the Browser A 902 and a second tree (e.g., Tree B) associated with the Browser B 904 are stored on the Server AB 906. In a particular embodiment, the Tree A is stored in a first data store 908 and the Tree B is stored in a second data store 910. Although illustrated as being stored in two separate data stores, Tree A and Tree B may be stored in a single data store.

According to another embodiment (middle architecture), the Browser A 902 is coupled to a first server 912 (e.g., Server A) that includes a data store 916 that stores Tree A, and the Browser B 904 is coupled to a second server 914 (e.g., Server B) that includes a data store that stores Tree B. The REST API may be used to synchronize or coordinate the respective trees.

According to another embodiment (lower architecture), a peer-to-peer configuration is illustrated where a server 920 (e.g., Server AB) initially connects the Browser A 902 and the Browser B 904, but after the Browsers 902, 904 retrieve their respective initial web pages, they communicate directly without going through the server 920 using a data channel 922 between the local trees. For example, an update sequence may be performed as follows: the Browser A 902 updates Tree A through its REST API over TCP/IP; the Tree A updates Tree B through its REST API over the data channel 922 or via the server 920; the Tree B notifies the Browser B 904 over JavaScript API.

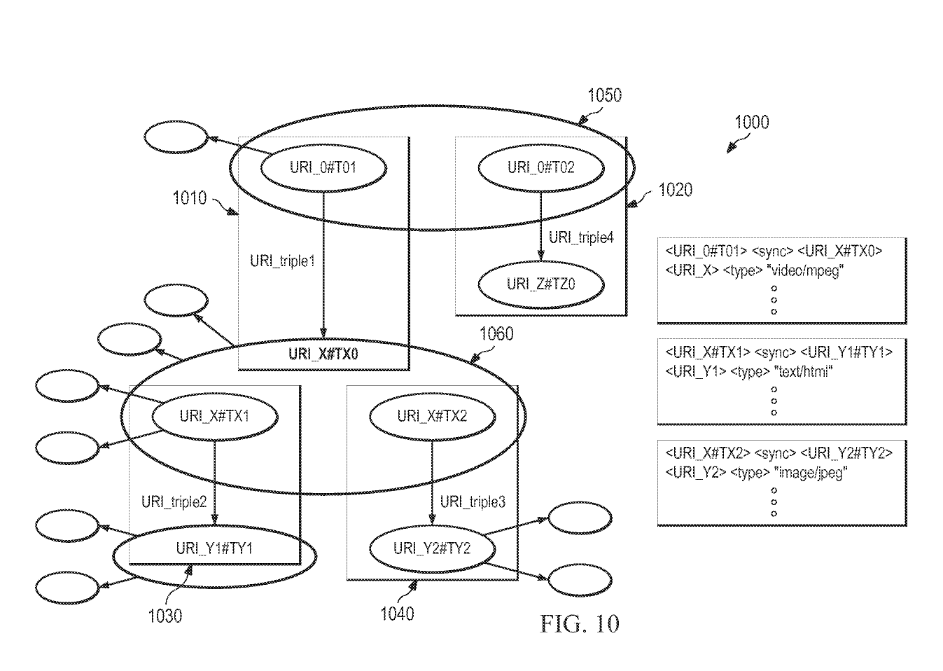

Turning to FIG. 10, there is illustrated a resource model 1000 of a hypermedia synchronization tree. As illustrated, each <sync> triple (e.g., URI_triple1, URI_triple2, URI_triple3 and URI_triple4) is enclosed by a “rectangle” and treated as a resource with well-known subordinate resources subject, predicate, and object. For example, URI_triple1 is illustrated as being enclosed by rectangle 1010, URI_triple4 is illustrated as being enclosed by rectangle 1020, URI_triple2 is illustrated as being enclosed by rectangle 1030 and URI_triple3 is illustrated as being enclosed by rectangle 1040. As illustrated, each rectangle 1010, 1020, 1030, 1040 is disconnected from the other rectangles such that they have no intersection with each other. However, the REST API requires that resources are navigable from one resource to another resource no matter where you start (e.g., resources must be connected).

The present disclosure introduces the concept of a “super node” to accomplish this “resource navigability” requirement. A super node is a node that contains the subject of a <sync> triple with the object of another <sync> triple. To illustrate, a super node 1060 overlaps with the rectangles 1010, 1030 and 1040 that contain triples URI_triple1, URI_triple2 and URI_triple3, respectively. The super node 1060 is generated because the subject of triple2 (e.g., URI_X#TX1), the subject of triple3 (e.g., URI_X#TX2) and the object of triple1 (e.g., URI_X#TX0) all share a common “base URI”. The base URI may be defined as the resulting URI after removal of the media fragment (e.g., the identifier or the hashtag and the portion that follows the hashtag (e.g., “#xxx”)). For example, as illustrated in FIG. 10, if the hashtag and what follows the hashtag is removed in triple1 (e.g., remove “#TX0” from “URI_X#TX0”), triple2 (e.g., remove “#TX1” from “URI_X#TX1”), and triple3 (e.g., remove “#TX2” from “URI_X#TX2”), the base URI (e.g., URI_X) is the same for each of the triples. In other words, a super node contains the media fragment URIs that point to the same resource (e.g., URI_X), but at different intervals (e.g., #TX0; #TX1; #TX2).

After forming the super node 1060, a relationship may be formed between the triples. For example, triple2 and triple3 may be treated as the children of triple1. Thereafter, another predicate (e.g., <child>) may be introduced for the triple1, triple2, and triple3 relationship (e.g., <URI_triple1> <child> <URI_triple2>, <URI_triple1> <child> <URI_triple3>). As another example, a super node 1050 may be formed between triple1 and triple4 because triple1 and triple4 contain media fragment URIs that point to the same resource (e.g., URI_{—}0), but at different intervals (e.g., #T01 and #T02). After forming the super node 1050, another relationship may be formed between triple1 and triple4. For example, triple1 and triple4 may be treated as siblings. Thereafter, another predicate (e.g., <sibling>) may be introduced for the triple1, triple4 relationship (e.g., <URI_triple1> <sibling> <URI_triple4>).

Because the triples are connected via super nodes, each triple can be treated as a resource. Therefore, a protocol can be devised to perform operations such as an edge creation operation, an edge retrieval operation, a tree update operation, and an edge deletion operation.

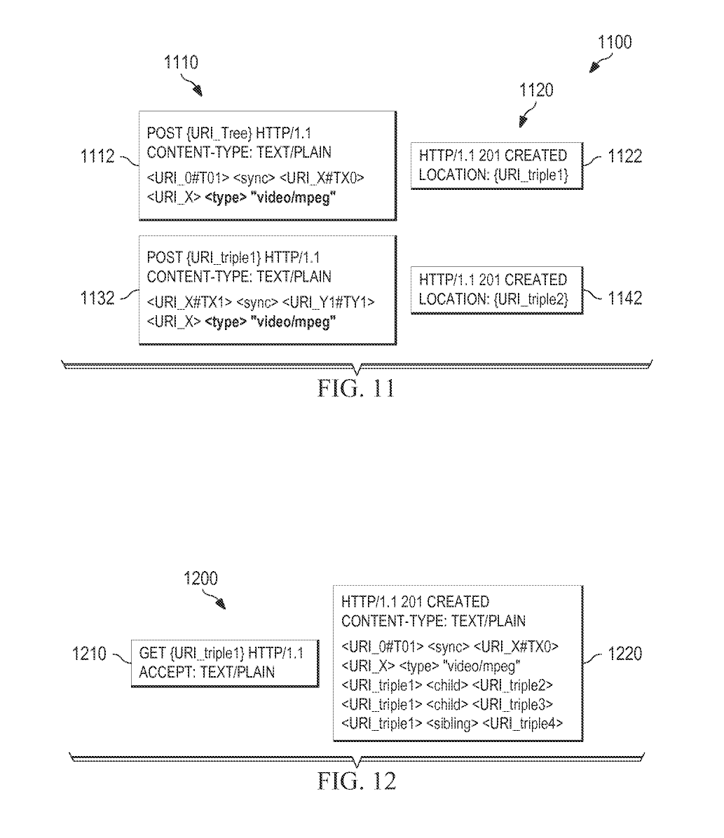

For example, FIG. 11 illustrates an operation 1100 to add a new edge for REST API over HTTP 1.1. This operation may be used when a user adds a new synchronization edge to the tree. The operation 1100 includes a request 1110 and a response 1120. To illustrate, to add a single triple to a tree, a POST HTTP/1.1 message is sent to the URI of the tree (e.g., POST {URI_Tree} HTTP/1.1) as illustrated at 1112. The {URI_Tree} is the entry point to the REST API provided to the client.

A <sync> triple is included within the POST message (e.g., <URI_{—}0#T01> <sync> <URI_X#TX0>. In addition, an additional auxiliary predicate (e.g., a <type> predicate) may be included within the POST message (e.g., <URI_X> <type> “video/mpeg”). Thereafter, the message 1112 is sent to the server (not shown), and the server generates the response 1120. If everything goes well, the response 1120 includes a URI to the triple (e.g., {URI_triple1}) as illustrated at 1122.

Alternatively, or in addition, a triple may be added to another node in the tree. For example, to add a single triple to a node, a POST message is sent to the URI of the triple (e.g., POST {URI_triple1}) as illustrated at 1132. A <sync> triple is included within the POST message (e.g., <URI_X#TX1> <sync> <URI_Y1#TY1>. In addition, an additional auxiliary predicate (e.g., a <type> predicate) may be included within the POST message (e.g., <URI_X> <type> “video/mpeg”). Thereafter, the message 1132 is sent to the server (not shown), and the server generates the response 1120. If everything goes well, the response 1120 includes a URI to the triple (e.g., {URI_triple2}) as illustrated at 1142. Other types of RDF representations, such as XML, can be submitted.

FIG. 12 illustrates an operation 1200 to retrieve a triple for REST API over HTTP 1.1. This operation may be used to find out the current state of a synchronization edge. Quad representation may be used to identify the main triple in the graph. On success, an RDF graph may be returned with the following triples: the <sync> triple and its auxiliary triples; triples linking its object super node to the children, if any; and triples linking its subject to a super node, if any. Other types of RDF representations, such as XML, can be returned.

The operation 1200 includes a request 1210 and a response 1220. For example, to retrieve a triple, a GET HTTP/1.1 message is sent to the URI of the triple (e.g., GET {URI_triple1} HTTP/1.1) as illustrated at 1210. The GET message indicates what kind of content the server can accept (e.g., text, plain, etc.). Thereafter, the GET message is sent to the server (not shown), and the server generates the response 1220. In the response 1220, the server returns the triple (if found). For example, a <sync> triple may be included within the response 1220 (e.g., <URI_{—}0#T01> <sync> <URI_X#TX0>). In addition, an additional auxiliary predicate (e.g., a <type> predicate) may be included within the response 1220 (e.g., <URI_X> <type> “video/mpeg”). In addition, links to other triples such as child and sibling triples may be included within the response 1220 (e.g., <URI_triple1> <child> <URI_triple2>; <URI_triple1> <child> <URI_ triple3>; <URI_triple1> <sibling> <URI_triple4>).

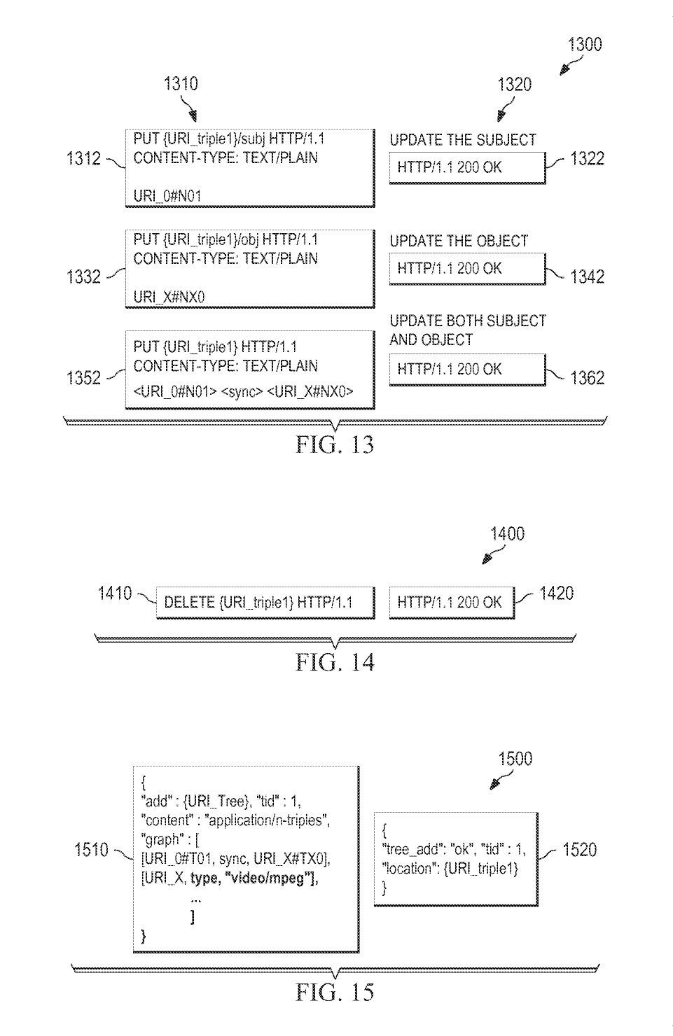

FIG. 13 illustrates operations 1300 to update a tree for REST API over HTTP 1.1. These operations may be used whenever a user changes the start time and/or duration of a synchronization edge in the tree. The operation 1300 includes a request 1310 and a response 1320. For example, to update a tree, a PUT HTTP/1.1 message is sent to the URI of the triple. For example, to update the subject, a PUT message is sent to the URI of the triple (e.g., PUT {URI_triple1}/subj HTTP/1.1) as illustrated at 1312. The PUT message includes a new fragment URI corresponding to the new subject (e.g., URI_{—}0#N01). Thereafter, the PUT message is sent to the server (not shown), and if all goes well the server generates the response 1322.

As another example, to update the object, a PUT message is sent to the URI of the triple (e.g., PUT {URI_triple1}/obj HTTP/1.1) as illustrated at 1332. The PUT message includes a new fragment URI corresponding to the new object (e.g., URI_X#NX0). Thereafter, the PUT message is sent to the server (not shown), and if all goes well the server generates the response 1332.

As yet another example, to update both the subject and the object, a PUT message is sent to the URI of the triple (e.g., PUT {URI_triple1}/HTTP/1.1) as illustrated at 1352. The PUT message includes the content of the new triple (e.g., <URI0#N01> <sync> <URI_X#NX0>). Thereafter, the PUT message is sent to the server (not shown), and if all goes well the server generates the response 1362.

FIG. 14 illustrates an operation 1400 to delete an edge for REST API over HTTP 1.1. This operation may be used whenever a user removes a synchronization edge from the tree. In particular embodiments, the edge and the child nodes may be removed from the tree model, but the RDF triples can still be kept if needed by the application. The operation 1400 includes a request 1410 and a response 1420. For example, to delete an edge, a DELETE HTTP/1.1 message is sent to the URI of the triple (e.g., DELETE {URI_triple1} HTTP/1.1) as illustrated at 1410. Thereafter, the DELETE message is sent to the server (not shown), and if all goes well the server generates the response 1420.

FIG. 15 illustrates an operation 1500 to add a new edge based on JavaScript Object Notation (JSON) for REST API over WebSocket. The operation 1500 includes a request 1510 and a response 1520. For example, to add a triple to a tree, an “add” WebSocket message is sent to the URI of the tree (e.g., “add”: {URI_Tree},“tid”:1) as illustrated at 1510. A transaction identification (“tid”) is included within the “add” message to correlate responses with requests because of the asynchronous nature of the JSON protocol. In addition, a sync triple is included within the “add” message (e.g., [URI_{—}0#T01, sync, URI_X#TX0]. In addition, an additional auxiliary predicate (e.g., a type predicate) may be included within the “add” message (e.g., [URI_X, type, “video/mpeg”]). Thereafter, the message 1510 is sent to the server (not shown), and the server generates the response 1520. If everything goes well, the response 1520 includes a URI to the triple (e.g., {URI_triple1}) as illustrated.

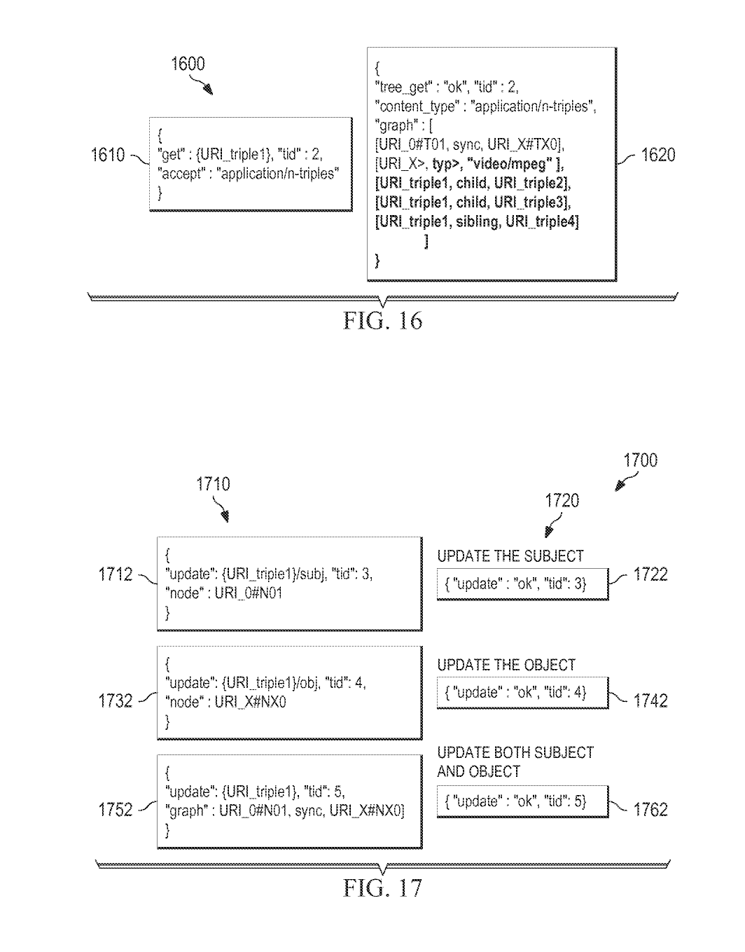

FIG. 16 illustrates an operation 1600 to retrieve a triple based on JSON for REST API over WebSocket. The operation 1600 includes a request 1610 and a response 1620. For example, to retrieve a triple, a “get” WebSocket message is sent to the URI of the triple (e.g., “get” {URI_triple1}, “tid”:2) as illustrated at 1610. The “get” message indicates what kind of content the server can accept (e.g., application/n-triples). Thereafter, the “get” message is sent to the server (not shown), and the server generates the response 1620. In the response 1620, the server returns the triple (if found). For example, a sync triple may be included within the response 1620 (e.g., [URI_{—}0#T01, sync, URI_X#TX0]). In addition, an additional auxiliary predicate (e.g., a type predicate) may be included within the response 1620 (e.g., [URI_X>, typ>, “video/mpeg”]). In addition, links to other triples such as child and sibling triples may be included within the response 1620 (e.g., [URI_triple1], child, URI_triple2], [URI_triple1, child, URI_triple3], [URI_triple1, sibling, URI_triple4]).

FIG. 17 illustrates an operation 1700 to update a tree based on JSON for REST API over WebSocket. The operation 1700 includes a request 1710 and a response 1720. For example, to update a tree, an “update” WebSocket message is sent to the URI of the triple. For example, to update the subject, an “update” message is sent to the URI of the triple (e.g., “update”: {URI_triple1}/subj, “tid”:3) as illustrated at 1712. The “update” message includes a new fragment URI corresponding to the new subject (e.g., URI_{—}0#N01). Thereafter, the “update” message is sent to the server (not shown), and if all goes well the server generates the response 1722.

As another example, to update the object, an “update” message is sent to the URI of the triple (e.g., “update” {URI_triple1}/obj, “tid”:4) as illustrated at 1732. The “update” message includes a new fragment URI corresponding to the new object (e.g., URI_X#NX0). Thereafter, the “update” message is sent to the server (not shown), and if all goes well the server generates the response 1732.

As yet another example, to update both the subject and the object, an “update” message is sent to the URI of the triple (e.g., “update” {URI_triple1}, “tid”:5) as illustrated at 1752. The “update” message includes the content of the new triple (e.g., [URI_{—}0#N01, sync, URI_X#NX0]). Thereafter, the “update” message is sent to the server (not shown), and if all goes well the server generates the response 1762.

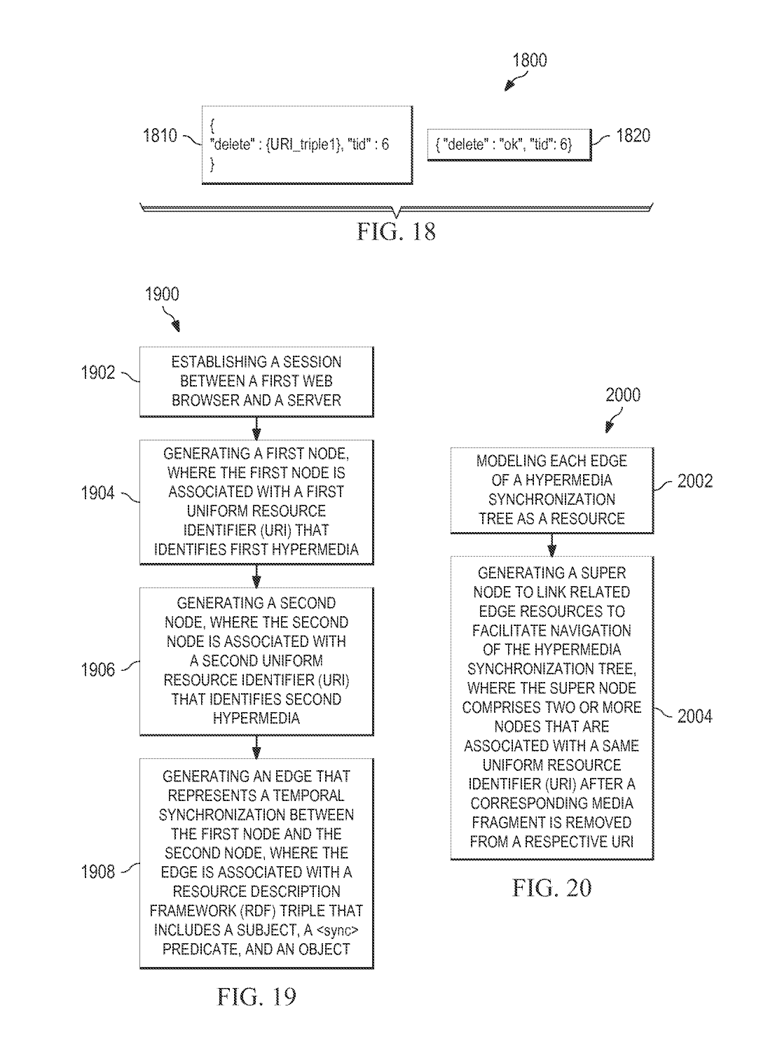

FIG. 18 illustrates an operation 1800 to delete an edge based on JSON for REST API over WebSocket. The operation 1800 includes a request 1810 and a response 1820. For example, to delete an edge, a “delete” WebSocket message is sent to the URI of the triple (e.g., “delete” {URI_triple1}, “tid”:6) as illustrated at 1810. Thereafter, the “delete” message is sent to the server (not shown), and if all goes well the server generates the response 1820.

FIG. 19 illustrates a flow diagram illustrating a method 1900 of constructing a hypermedia synchronization tree. A session is established between a first web browser and a server, at 1902. For example, the server 906 of FIG. 9 may establish the session 302 of FIG. 3 between the web browser 902 and the server 906.

A first node is generated, where the first node is associated with a first uniform resource identifier (URI) that identifies first hypermedia, at 1904. For example, the “horizontal arrow” 304 represents a node that is associated with URI1 that identifies hypermedia (e.g., browser A receives local video as identified by (A_URI1) from a camera).

A second node is generated, where the second node is associated with a second URI that identifies second hypermedia, at 1906. For example, the “horizontal arrow” 312 represents a node that is associated with URI5 that identifies hypermedia (e.g., a segment of YouTube video as identified by (URI5)).

An edge is generated that represents a temporal synchronization between the first node and the second node, at 1908. The edge is associated with a resource description framework (RDF) triple that includes a subject, a <sync> predicate, and an object. For example, the “vertical line” A6 represents an edge where User A links a segment of the YouTube video as identified by (URI5) to the local video as identified by A_URI1). The edge A6 may be associated with the RDF triple <A_URI1#t=50> <sync> <URI5#t=30,120> as illustrated in Table 1, where A_URI1#t=50 illustrates the subject, <sync> illustrates the <sync> predicate, and URI5#t=30,120 illustrates the object.

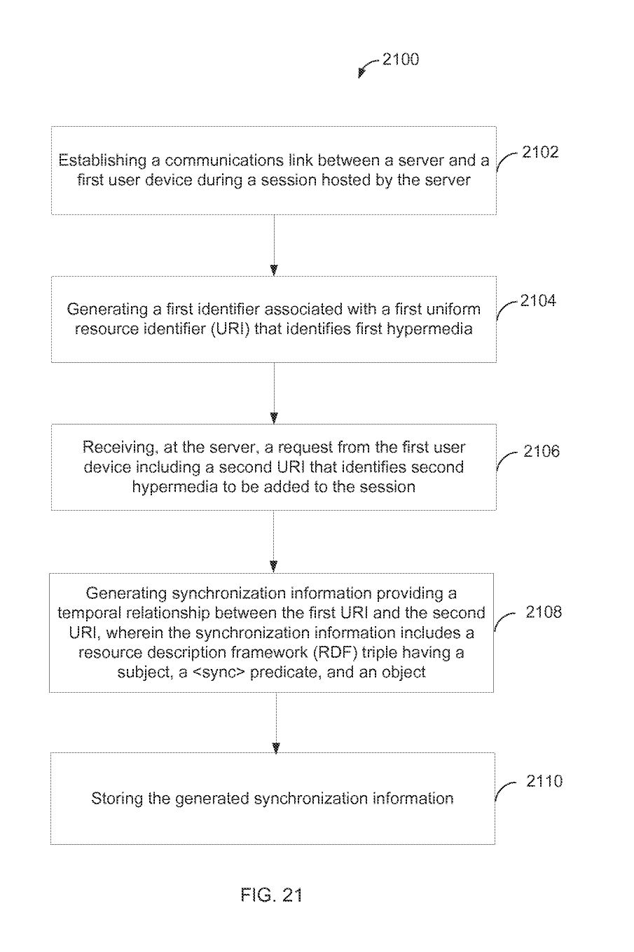

FIG. 20 illustrates a flow diagram illustrating a method 2000 of transforming a hypermedia synchronization tree to a representational state transfer (REST) resource model. Each edge of a hypermedia synchronization tree is modeled as a resource, at 2002. For example, each <sync> triple (e.g., URI_triple1, URI_triple2, URI_triple3 and URI_triple4) illustrated in FIG. 10 is enclosed by a “rectangle” and treated as a resource with well-known subordinate resources subject, predicate, and object.

A super node is generated to link related edge resources to facilitate navigation of the hypermedia synchronization tree, at 2004. The super node comprises two or more nodes that are associated with the same URI after a corresponding media fragment is removed from a respective URI. For example, the super node 1060 is generated because the subject of triple2 (e.g., URI_X#TX1), the subject of triple3 (e.g., URI_X#TX2) and the object of triple1 (e.g., URI_X#TX0) all share a common base URI (e.g., URI_X).

Some of the benefits of the embodiments described above with respect to coordination of distributed hypermedia synchronization trees with REST API include:
REST API separates services from implementations such that REST servers can use a variety of RDF storage techniques;
REST servers can change IP address, URI namespace and transport protocol without impacting well-design clients;
Idempotent operations allow retrial after partial failure without corrupting resource states;
System performance can be improved through layered caches;
HTTP and AJAX have built-in support for REST, and REST API can also be implemented over WebSocket, XMPP and WebRTC Data Channel;
Efficient implementations because most RDF processors create an internal identifier for each triple;
Use of URI to address predicates allows clients to perform fine-grained updates efficiently without specifying a current state of the tree to avoid potential race conditions; and
Clients can retrieve a small part of a large synchronization tree to save network bandwidth when users in a conference are focused on a few synchronized hypermedia in the tree.

FIG. 21 illustrates a flow diagram illustrating a method 2100 for real-time hypermedia synchronization within a session hosted by a server. The method 2100 includes establishing a communications link between the server and a first user device during the session, at 2102. A first identifier associated with a first uniform resource identifier (URI) that identifies first hypermedia is generated, at 2104.

The method 2100 includes receiving, at the server, a request from the first user device including a second URI that identifies second hypermedia to be added to the session, at 2106. The method 2100 includes generating synchronization information providing a temporal relationship between the first URI and the second URI, where the synchronization information includes a resource description framework (RDF) triple having a subject, a <sync> predicate, and an object, at 2108. The generated synchronization information is stored, at 2110.

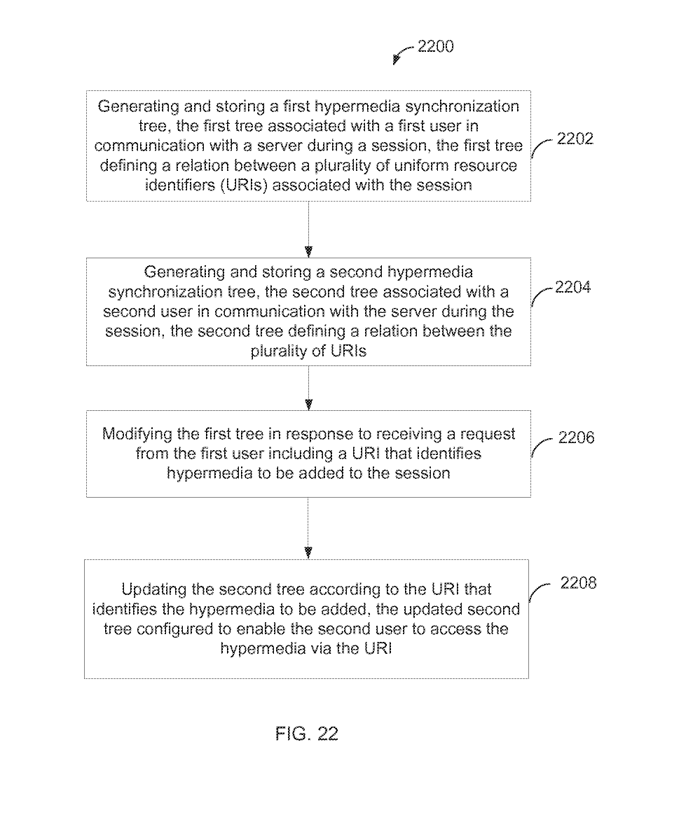

FIG. 22 illustrates a flow diagram illustrating a method 2200 for transforming a hypermedia synchronization tree to a representational state transfer (REST) resource model. The method 2200 includes generating and storing a first hypermedia synchronization tree, the first tree associated with a first user in communication with a server during a session, the first tree defining a relation between a plurality of uniform resource identifiers (URIs) associated with the session, at 2202.

The method includes generating and storing a second hypermedia synchronization tree, the second tree associated with a second user in communication with the server during the session, the second tree defining a relation between the plurality of URIs, at 2204.

The method includes modifying the first tree in response to receiving a request from the first user including a URI that identifies hypermedia to be added to the session, at 2206. The method includes updating the second tree according to the URI that identifies the hypermedia to be added, the updated second tree configured to enable the second user to access the hypermedia via the URI, at 2208.

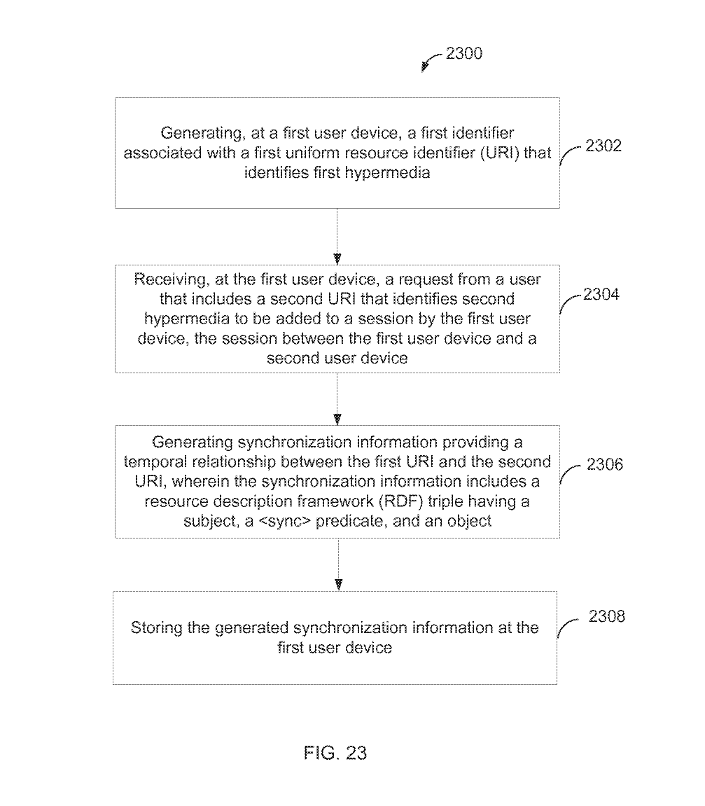

FIG. 23 illustrates a flow diagram illustrating a method 2300 for real-time hypermedia synchronization during a session between a first user device and a second user device. The method includes generating, at the first user device, a first identifier associated with a first uniform resource identifier (URI) that identifies first hypermedia, at 2302. The method includes receiving, at the first user device, a request from a user that includes a second URI that identifies second hypermedia to be added to the session by the first user device, at 2304. The method includes generating synchronization information providing a temporal relationship between the first URI and the second URI, where the synchronization information includes a resource description framework (RDF) triple having a subject, a <sync> predicate, and an object, at 2306. The method includes storing the generated synchronization information at the first user device, at 2308.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for real-time hypermedia synchronization within a session hosted by a server, the method comprising:
establishing a communications link between the server and a first user device during the session;
generating a first identifier associated with a first uniform resource identifier (URI) that identifies first hypermedia;
receiving, at the server, a request from the first user device including a second URI that identifies second hypermedia to be added to the session;
generating synchronization information providing a temporal relationship between the first URI and the second URI, wherein the synchronization information includes a resource description framework (RDF) triple having a subject, a <sync> predicate, and an object; and
storing the generated synchronization information.

2. The method in accordance with claim 1, wherein the subject comprises the first URI and a time reference.

3. The method in accordance with claim 1, wherein the object comprises the second URI.

4. The method in accordance with claim 1, further comprising:
receiving, at the server, a second request from the first user device including a third URI that identifies third hypermedia to be added to the session.

5. The method in accordance with claim 1, further comprising:
establishing a communications link between the server and a second user device during the session;
receiving, at the server, a request from the second user device including a fourth URI that identifies fourth hypermedia to be added to the session;
generating second synchronization information providing a temporal relationship between the first URI and the fourth URI, wherein the synchronization information includes an RDF triple having a subject, a <sync> predicate, and an object; and
storing the generated second synchronization information.

6. The method in accordance with claim 1, wherein the first URI comprises video generated at the first user device and the second URI comprises at least one of the following: video, web page link, audio, image, graphics, or plain text.

7. The method in accordance with claim 1, wherein at least one of the first URI and the second URI comprises media fragment syntax.

8. The method in accordance with claim 7, wherein the synchronization information is generated at least in part based on a delay relative to a current session time, wherein the delay is determined by the server.

9. The method in accordance with claim 7, wherein the synchronization information is generated at least in part based on a delay relative to a current session time, wherein the delay is determined by the first user device.

10. An apparatus for real-time hypermedia synchronization within a session, the apparatus comprising:
a processor; and
memory coupled to the processor;
wherein the apparatus is configured to:
establish a communications link between the apparatus and a first user device during the session;
generate a first identifier associated with a first uniform resource identifier (URI) that identifies first hypermedia;
receive a request from the first user device including a second URI that identifies second hypermedia to be added to the session;
generate synchronization information providing a temporal relationship between the first URI and the second URI, wherein the synchronization information includes a resource description framework (RDF) triple having a subject, a <sync> predicate, and an object; and
store the generated synchronization information.

11. The apparatus in accordance with claim 10, wherein the subject comprises the first URI and a time reference.

12. The apparatus in accordance with claim 10, wherein the object comprises the second URI.

13. The apparatus in accordance with claim 10, wherein the apparatus is further configured to:
receive a second request from the first user device including a third URI that identifies third hypermedia to be added to the session.

14. The apparatus in accordance with claim 10, wherein the apparatus is further configured to:
establish a communications link between the server and a second user device during the session;
receive a request from the second user device including a fourth URI that identifies fourth hypermedia to be added to the session;
generate second synchronization information providing a temporal relationship between the first URI and the fourth URI, wherein the synchronization information includes an RDF triple having a subject, a <sync> predicate, and an object; and
store the generated second synchronization information.

15. The apparatus in accordance with claim 10, wherein the first URI comprises video generated at the first user device and the second URI comprises at least one of the following: video, web page link, audio, image, graphics, or plain text.

16. The apparatus in accordance with claim 10, wherein at least one of the first URI and the second URI comprises media fragment syntax.

17. The apparatus in accordance with claim 16, wherein the synchronization information is generated at least in part based on a delay relative to a current session time, wherein the delay is determined by the apparatus.

18. The apparatus in accordance with claim 16, wherein the synchronization information is generated at least in part based on a delay relative to a current session time, wherein the delay is determined by the first user device.

19. A method of transforming a hypermedia synchronization tree to a representational state transfer (REST) resource model, the method comprising:
generating and storing a first hypermedia synchronization tree, the first tree associated with a first user in communication with a server during a session, the first tree defining a relation between a plurality of uniform resource identifiers (URIs) associated with the session;
generating and storing a second hypermedia synchronization tree, the second tree associated with a second user in communication with the server during the session, the second tree defining a relation between the plurality of URIs;
modifying the first tree in response to receiving a request from the first user including a URI that identifies hypermedia to be added to the session; and
updating the second tree according to the URI that identifies the hypermedia to be added, the updated second tree configured to enable the second user to access the hypermedia via the URI.

20. The method in accordance with claim 19, wherein the first synchronization tree defines a temporal relationship between two or more of the URIs and the second synchronization tree defines a temporal relationship between two or more of the URIs.

21. The method in accordance with claim 19, wherein the first tree comprises a first resource description framework (RDF) triple having a subject, a <sync> predicate, and an object and the second tree comprises a second resource description framework (RDF) triple having a subject, a <sync> predicate, and an object.

22. A method for real-time hypermedia synchronization during a session between a first user device and a second user device, the method comprising:
generating, at the first user device, a first identifier associated with a first uniform resource identifier (URI) that identifies first hypermedia;
receiving, at the first user device, a request from a user that includes a second URI that identifies second hypermedia to be added to the session by the first user device;
generating synchronization information providing a temporal relationship between the first URI and the second URI, wherein the synchronization information includes a resource description framework (RDF) triple having a subject, a <sync> predicate, and an object; and
storing the generated synchronization information at the first user device.

23. The method in accordance with claim 22, further comprising:
transmitting from the first user device the synchronization information to the second user device; and
retrieving the second hypermedia at the second user device in response to the synchronization information.
